(19) United States
(12) Patent Application Publication
(10) Pub. No.: US 2012/0293865 A1
(43) Pub. Date: Nov. 22, 2012

(54) Autoluminescence Reticle Embedded Scope

(75) Inventors: Tsung-Mou Tsai, Taichung (TW); Guo-Shuen Huang, Taichung (TW)

(73) Assignee: ASIA OPTICAL CO., INC., Taichung (TW)

(21) Appl. No.: 13/112,394

(22) Filed: May 20, 2011

(51) Int. Cl. G02B 23/00

(52) U.S. Cl. 359/428

(57) ABSTRACT

A scope with an autoluminescence reticle is provided, wherein the autoluminescence reticle is formed by coating autoluminescence materials on a glass. The autoluminescence reticle does not need a power supply, but can radiate light at night or under a low light environment.

### BACKGROUND OF THE INVENTION

1. Field of the Invention

The present invention relates to a scope, and in particular relates to a scope with an autoluminescence reticle.

2. Description of the Related Art

A scope provided with a reticle is commonly used for aiming at a target or surveying. When aiming at a target, the scope, or a telescopic sight, is installed on a firearm. A reticle of the scope is set for precision aiming at a target. When surveying, the scope may be a telescope or a microscope. The reticle of the telescope or microscope is designed for various special purposes.

FIG. 1 is a section view illustrating a scope provided with a reticle of prior art. As shown in FIG. 1, A scope 1 of the prior art comprises a body 10, an objective outer tube 11, an upright inner tube 12, an eyepiece 13, a rotating base 14, a Windage-Elvation housing unit 15, and a reticle 16. Here, the reticle 16 is made by electroforming and not illuminated. For the scope 1, users cannot see the reticle at night or under a low light environment.

FIG. 2 is a section view illustrating a scope provided with an illuminated reticle of prior art. As shown in FIG. 2, a scope 2 of the prior art comprises a body 20, an objective outer tube 21, an upright inner tube 22, an eyepiece 23, a rotating base 24, a Windage-Elvation housing unit 25, a reticle 26, a light emitting diode 27, and a battery room 28. Here, the reticle 26 is made by coating reflective materials, such as Chromium, Nickel, or Zinc, on a glass. As the reticle 26 can reflect light illuminated from the light emitting diode 27, users can use the scope 2 at night or under a low light environment. However, because the light emitting diode 27 needs a power supply, the battery room 28 is necessary, so that the weight, the volume, and the cost of the scope 2 are higher than a scope not provided with an illuminated reticle.

### BRIEF SUMMARY OF THE INVENTION

The purpose of the invention is to provide a scope with a reticle, which can be used at night or under a low light environment and does not need a power supply, such as batteries.

The scope of the invention includes a tube-shaped body and a reticle, disposed in the tube-shaped body, wherein the reticle is made of autoluminescence materials.

In the scope of the invention, the autoluminescence materials include fluorescence materials or phosphorescence materials.

In the scope of the invention, the reticle is in the form of a crosshair coated on a glass.

In the scope of the invention, the fluorescence materials or the phosphorescence materials include rare earth aluminates.

According to the invention, the scope provided with an autoluminescence reticle can be used at night or under a low light environment, which is different from the scope provided with an electroformed reticle. Further, in comparison with the scope provided with an illuminated reticle of prior art, the scope provided with an autoluminescence reticle of the invention does not need a power supply, so that the cost of implementing an LED, a battery room and a power control circuit can be eliminated.

### BRIEF DESCRIPTION OF THE DRAWINGS

The present invention can be more fully understood by reading the subsequent detailed description and examples with references made to the accompanying drawings, wherein:

FIG. 1 is a section view illustrating a scope provided with a reticle of prior art.

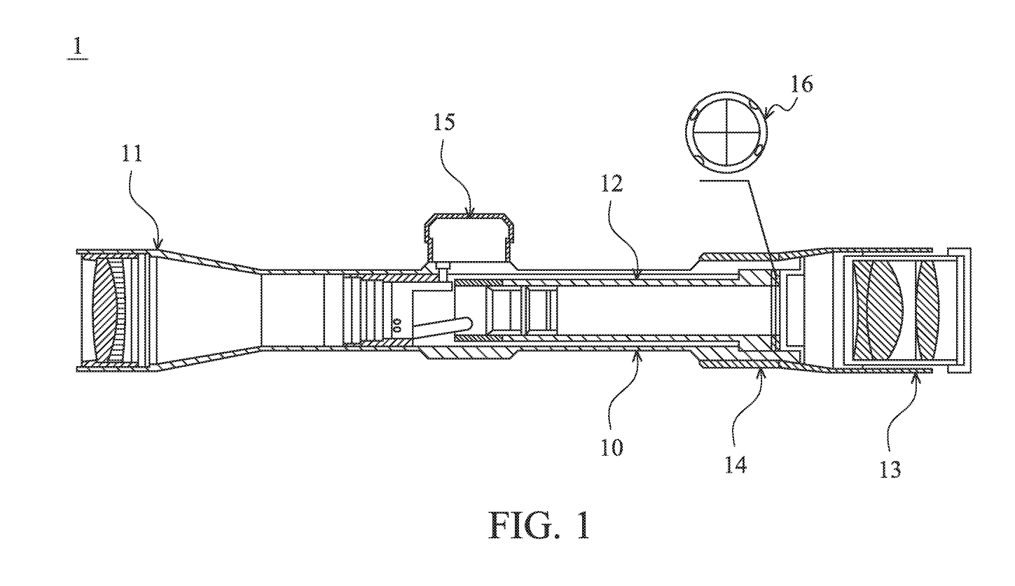

FIG. 2 is a section view illustrating a scope provided with an illuminated reticle of prior art.

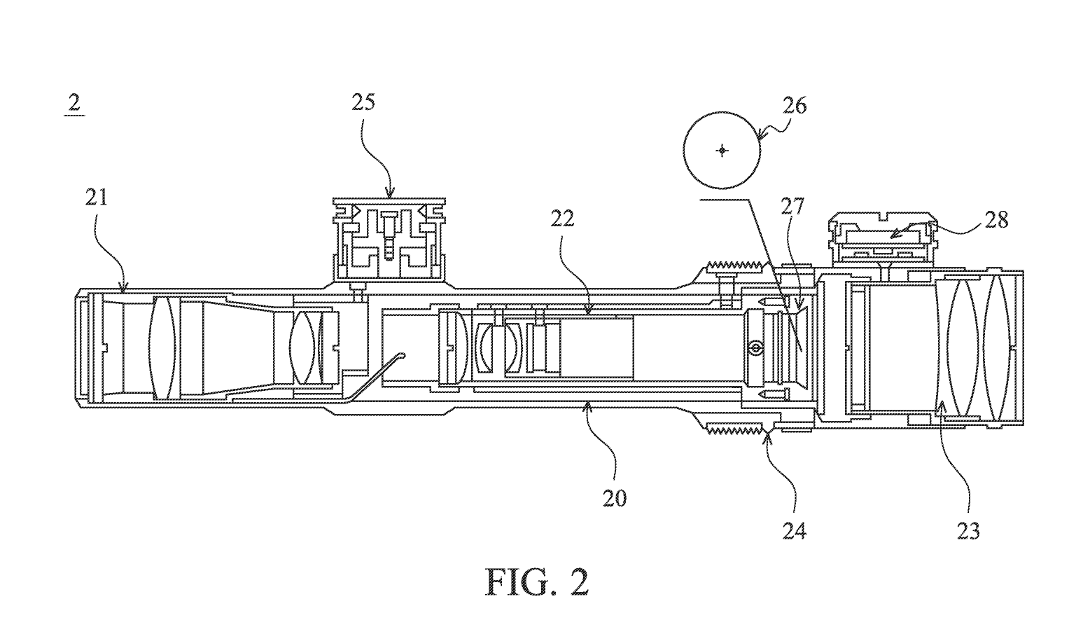

FIG. 3 is a section view illustrating a scope provided with an autoluminescence reticle according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

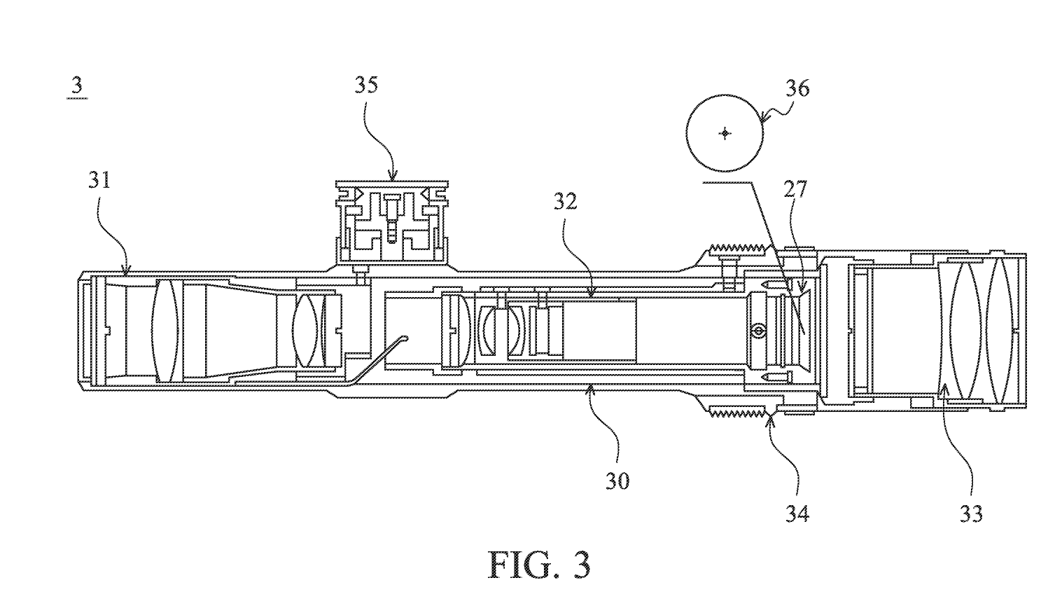

FIG. 3 is a section view illustrating a scope provided with an autoluminescence reticle according to the invention. As shown in FIG. 3, A scope 3 according to the invention comprises a body 30, an objective outer tube 31, an upright inner tube 32, an eyepiece 33, a rotating base 34, a Windage-Elvation housing unit 35, and a reticle 36. Here, the reticle 36 is made by coating autoluminescence materials, such as fluorescence materials or phosphorescence materials, on a glass. The autoluminescence materials can be formed on the glass by vacuum vapor deposition, spattering, ionic deposition, or the like. The reticle 36 is usually a crosshair represented as intersecting lines in the shape of a cross.

The characteristic of the autoluminescence materials is that the autoluminescence materials absorb the energy of external light and then radiate light. When used at night or under a low light environment, the autoluminescence materials allow human eyes to recognize an adjusted brightness. Because the autoluminescence materials need to absorb the energy of external light to radiate light, the light path of the external light in the scope is preferred to be optically designed to pass through the location of the glass coated with the autoluminescence materials. Therefore, the autoluminescence materials are illuminated with external light to restore energy when the scope is under a bright environment. When the external light is deficient, the autoluminescence materials radiate the light to let users clearly see the reticle. The energy can be restored in the autoluminescence materials and then be released repeatedly.

In the invention, the autoluminescence materials comprise fluorescence materials or phosphorescence materials. The fluorescence materials or the phosphorescence materials comprise rare earth aluminates.

According to the invention, the scope provided with an autoluminescence reticle can be used at night or under a low light environment, which is different to the scope provided with an electroformed reticle. Further, the scope provided with an autoluminescence reticle of the invention uses solar energy or other light sources to radiate light, which is environmentally friendly and saves energy. In comparison with the scope provided with an illuminated reticle of prior art, the scope provided with an autoluminescence reticle of the invention does not need a power supply, so the costs of implementing an LED, a battery room and a power control circuit can be eliminated.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A scope, comprising
a tube-shaped body; and
a reticle, disposed in the tube-shaped body,
wherein the reticle is made of autoluminescence materials.

2. The scope as claimed in claim 1, wherein the autoluminescence materials comprise fluorescence materials or phosphorescence materials.

3. The scope as claimed in claim 1, wherein the reticle is in the form of a crosshair coated on a glass.

4. The scope as claimed in claim 2, wherein the fluorescence materials or the phosphorescence materials comprise rare earth aluminates.
